(19) United States
(12) Patent Application Publication
(10) Pub. No.: US 2007/0218421 A1
(43) Pub. Date: Sep. 20, 2007

(54) Procedure and device enabling facile tooth impression

(76) Inventors: Subhash C. Narang, Palo Alto, CA (US); Joseph L. Cortese, Fremont, CA (US)

Correspondence Address: Subhash C. Narang, 728 Garland Drive, Palo Alto, CA, 94303, US

(21) Appl. No.: 11/701,616

(22) Filed: Feb. 2, 2007

Related U.S. Application Data
(60) Provisional application No. 60/765,084, filed on Feb. 3, 2006.

(51) Int. Cl. A61C 5/14

(52) U.S. Cl. 433/136

(57) ABSTRACT

A procedure and device for enabling an accurate impression of a tooth by forcing the gingival sulcus tissue to predominantly compress rather than retract by utilizing a relatively hard shell in conjunction with an absorbent liner and imbibing/mixing the liner material with an astringent for hemostasis, an anesthetic to decrease patient discomfort and an antibiotic to minimize infection, and facilitate gingival healing. A procedure that will decrease postoperative discomfort and maximize periodontal health.

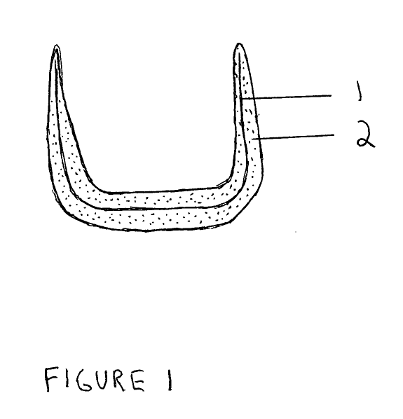

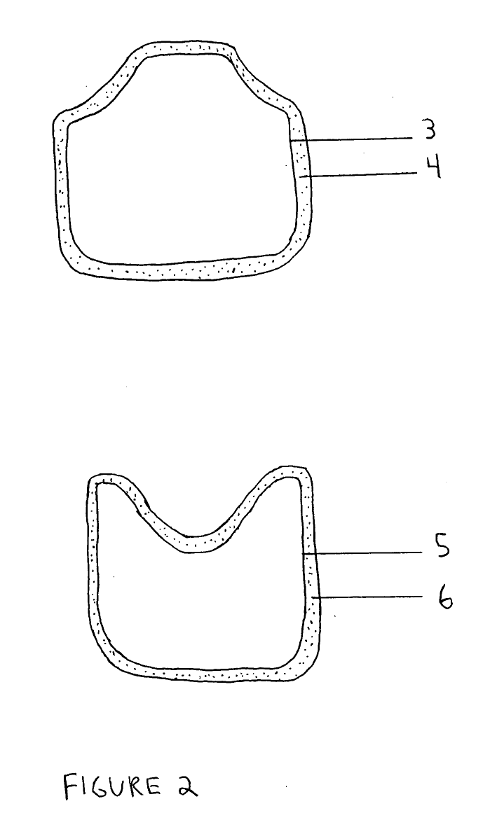

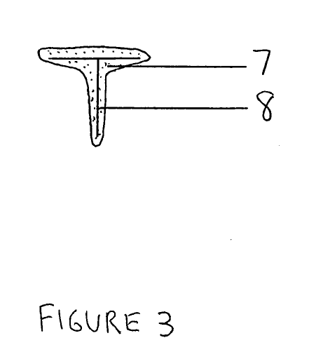

Dentists typically pack a cord around the base of a prepared tooth by mechanically forcing the cord between the tooth and the surrounding gingival sulcus tissue to retract the tissue. This cumbersome, painful procedure is required to enable the dentist to obtain an accurate impression of the tooth for the purpose of preparing a crown or a bridge. Placing the retraction cord in the narrow confined space between the teeth is even more difficult.

Pierre Rolland of Acteon group have introduced a syringable paste product in a cartridge called EXPASYL to allow gingival retraction without the use of a cord. The paste causes gingival retraction because it absorbs moisture from the tissue, thereby shrinking the tissue. The syringe needle is bent and the paste is forced into the base of the tooth. After a few minutes to affect hemostasis and retraction, the paste is thoroughly removed by washing and air spray. Lesage, U.S. Pat. No. 5,362,495, describes this technique.

Recently, Coltene-Whaledent have introduced a syringable, expanding, two part polyvinyl siloxane formulation that can be applied to the base of the tooth in a procedure very similar to the above cited EXPASYL product, followed by placement of a cotton Comprecap. The patient is then asked to bite down on the Comprecap to force the curing, expanding foam to retract the gingival sulcus tissue. After 5 minutes, the Comprecap and the “cured in place” polysiloxane foam is removed

Dragan, U.S. Pat. No. 5,676,543, had previously introduced a two step procedure for cordless retraction. In the first step, a mold of the tooth was prepared from a moldable silicone containing an astringent. The mold was then removed from the tooth and filled with a flowable, astringent containing material. The mold was again placed on the tooth and pressure was applied to the flowable material in the mold to affect retraction and hemostasis.

Dragan, U.S. Pat. No. 6,890,177 B2, have described the use of a dental dam prepared from a porous material containing a groove filled with a freshly placed impression material that is placed over a prepared tooth that has been covered previously with the impression material. The patient is required to apply biting pressure until the impression material sets. The dental dam with the attached impression material is then removed. The bleeding during tooth preparation needs to be controlled before applying the impression material.

EP 0092329 describes the fabrication of an expanding foam dressing pressure pack that helps in the retraction of gingival tissue.

DE 3736155 and DE 3737552 describe the use of a dental impression material containing pharmacological agents for retraction of the gingival tissue, for drying out, and for hemostasis. The material is injected into the sulcus to cause retraction. These injectable formulations are hard to place, especially between the teeth.

The prior art thus relies on either mechanical painful retraction or, injection of material around the tooth base followed by washing or mechanical removal or, multistep processes that can be imprecise, time consuming and cumbersome.

It is the objective of the present invention to overcome the drawbacks cited above by using a novel device that enables gentle retraction of the gingival sulcus tissue by causing predominantly compression rather than retraction resulting in more effective hemostasis due to enhanced compression and less trauma due to less tearing of the periodontal fibers.

It is a further objective of this invention to enable the dentist to compress and retract the gingival sulcus tissue in a single step.

It is another objective of this invention to allow the dentist to obtain a reimpression of the tooth without injecting the anaesthetic.

It is a further objective of this invention to compress/retract the hard to reach gingival tissue located in between the teeth by using an interproximal retractor version of the device.

The device of the present invention consists of a harder mold, made from metal, polymer, or ceramic, or a combination thereof. This mold is covered/coated with a softer absorbent material, which may contain an astringent, an anesthetic, and an antibiotic. The lip of the mold may be covered on both sides to minimize tissue damage.

Devices of several sizes are fabricated to accommodate both posterior and anterior teeth of all shapes and sizes.

The dentist prepares the tooth in the customary manner and the appropriate mold is fitted on the prepared tooth in a single, simple step. The patient applies biting pressure on the device, thus allowing the gingival tissue to compress down rather than retract by tearing the periodontal fibers. After a few minutes, the device is removed to allow the dentist to create a clean impression. No time is spent by the dentist in injecting materials or following multiple procedures as described in the prior art. One of the advantages of using the proposed device during reimpression is that no anesthetic injection is required because the absorbent layer in the device contains the anesthetic to minimize patient discomfort.

FIG. I illustrates the cross section of the device. 1 is the harder deformable shell composed of metal, plastic, ceramic or combinations of these materials. 2 is the softer absorbent component composed of foams, natural fibers, and other porous materials well known in the art.

The soft absorbent may contain astringents, anesthetics, antibiotics and combinations thereof well known in the art and described in the prior art cited above. FIG. II illustrates a cross section of the interproximal retractor coated with the softer superabsorbent and other additives as in the device of FIG. I.

We claim:

1. A device consisting of a hard shell and an absorbent component that enables the single step retraction of tissue around a tooth by applying mild pressure.

2. A device of claim 1, where the hard shell consists of one or more metals, ceramics, polymers, biomaterials, others and combinations thereof.

3. A device of claim 1, where the absorbent consists of cotton, starch, or other carbohydrate and/or proteinaceous materials.

4. A device of claim 1, where the absorbent consists of synthetic and natural materials including cellular materials and superabsorbents.

5. A device of claim 1 that incorporates a hemostatic agent.

6. A device of claim 1 that incorporates an anesthetic.

7. A device of claim 1 that incorporates an antibiotic.

8. An absorbent of claim 1, that expands on contact with body fluids such as saliva and blood.

9. A device of claim 1, where the hemostatic agent, anesthetic and the antibiotic are mixed or spatially selectively placed in the absorbent material.

10. An absorbent of claim 8 that expands upon generation of gas.

11. An absorbent of claim 8 that generates carbon dioxide by reaction between bicarbonate or a carbonate and a carboxylic acid.

12. A method for using the device of claim 1. Subsequent to anesthesia and preparation of a tooth for the purpose of restoration that requires a subgingival margin, a device or interproximal retractor of appropriate size is placed over prepared tooth or adjacent to proximal subgingival box. A mild to moderate occlusal force is applied by biting down and maintained for three to five minutes depending on perceived postoperative hemorrhagic exudates followed by removal of the device or the interproximal retractor, wiping clean with cotton soaked with 1.5% hydrogen peroxide, air drying, and proceeding with impression.

13. A method for using the device of claim 1 for reimpression. If a reimpression is called for, a device containing the anesthetic is placed over prepared tooth (after temporary crown has been removed). Mild biting pressure is applied over the device for less than a minute to gives anesthetic the time to take effect. More moderate pressure is then painlessly applied for the next three to five minutes. Wipe clean as in claim 12, air dry, and take impression.
